(19) United States
(12) Patent Application Publication
(10) Pub. No.: US 2015/0156090 A1
(43) Pub. Date: Jun. 4, 2015

(54) Systems and Methods for Monitoring Multiple Services

(71) Applicant: EarthLink, LLC, Atlanta, GA (US)

(72) Inventors: Frederick A. Paine, Fairport, NY (US); Michael A. Billington, East Syracuse, NY (US); Amanda Deusenbery, Penfield, NY (US); Michael Fuqua, Fairport, NY (US)

(21) Appl. No.: 14/096,413

(22) Filed: Dec. 4, 2013

(51) Int. Cl. H04L 12/26

(52) U.S. Cl. CPC H04L 43/08

(57) ABSTRACT

Methods and systems for monitoring multiple services provided via multiple systems. Status information for each of the multiple services is received. Status information comprises information about delivery of information technology, voice, data, or Internet service to multiple locations. The status information is assembled into a portal that when displayed provides a concurrent view of the status information for at least some of the multiple services. The portal is updated with status information based on receiving periodic status updates to the status information for each of the multiple systems. The status information from each of the multiple services is monitored to provide diagnostics through the portal pertaining to each of the multiple systems. Additionally, based on receiving notice of an error, tests may be run to identify the nature and extent of an anomaly or error.

### FIELD

This disclosure relates generally to systems and methods for monitoring multiple and differing services, including but not limited to network, communication, and other services.

### BACKGROUND

Businesses and individuals typically make use of multiple unrelated systems to access network, communication, utility, and other services, including but not limited to cloud services, mobile internet services, dial up internet services, other network services, etc. For example, through one or more wired or wireless networks a company may be provided with phone services, data services, Internet access services, and one or more other specific information technology services, such as access to particular database functionality or other software applications. Such services may be provided to the multiple locations for the company and each service at each location may be associated with separate customer accounts. Moreover, such services may involve different networks, different providers, different account access information, and otherwise be unrelated to one another. Managing, monitoring, and addressing issues with the potentially large number of systems and services that can be provided to a company is often burdensome and inefficient. Existing management and monitoring techniques are generally system specific. For example, a system may track the Internet service provided at a particular location and provide a bill for the Internet service provided at that location. A separate monitoring system may troubleshoot problems that arise with the Internet service provided at that particular location and may fail to provide information about Internet service provided at other locations, cloud services used through that Internet service, related telephone service, related utilities, and other services provided to the same and additional company locations.

Since companies and individuals rely on the combination of these services to provide the ecosystem in which they function for the day to day operations, it is often critical that service quality measures such as performance, availability or response time be monitored so that quality of services be maintained and potential disruptions of service or systems be avoided. However, existing techniques for monitoring services fail to adequately manage and monitor multiple systems and services that are provided at potentially multiple locations for a company or individual.

### SUMMARY

One exemplary embodiment involves receiving status information for each of the multiple services being provided to an individual or business customer. The status information comprises information about delivery of information technology, voice, data, or Internet service to multiple locations. The status information is assembled into a portal that when displayed combines, consolidates, and/or otherwise presents status information about the multiple services. The portal may be updated with status information, for example, based on receiving periodic status updates to the status information for each of the multiple services. The status information from each of the multiple services is monitored to provide diagnostics through the portal pertaining to each of the multiple services.

Additionally, techniques can be used to log events and address abnormal conditions in a portal or other system that receives information regarding multiple services. Monitored systems may generate status information that can be logged, categorized, and diagnosed to automatically determine or recommend a course of action. The course of action may be based on configurable rules that identify anomalies based on conditions from multiple systems. Depending on the course of action determined, a portal may be updated to incorporate status information of the logged event. Thus, a portal can be used to provide an ecosystem-wide view of all services that provides a big picture view of the services, facilitates comparison of the provision of a service at different locations, information, and facilitates the identification, diagnosis, and correction of errors and anomalies.

The diagnosis of errors and anomalies can involve performing various tests. Such tests may allow the system to determine whether the scope of an error with respect to locations and users, i.e., whether an error is present at one, two, three, etc. or all locations, and whether an error is effecting all users or only a specific user or user. In one embodiment, a test is performed using a specific user account and performed using a generic user account and the tests results are compared to identify whether the error is specific to the particular user account or more generally applicable.

These embodiments are mentioned not to limit or define the disclosure, but to provide examples of embodiments to aid understanding thereof. Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description with reference to the accompanying drawings, wherein:

FIG. 1 is a block diagram illustrating an example computing system for implementing certain embodiments;

FIG. 2 is a block diagram illustrating an exemplary computing environment for implementing certain embodiments;

FIG. 3 is an example of a dashboard display of an integrated portal;

FIG. 4 illustrates an exemplary method of monitoring services that are part of an eco-system;

FIG. 5 illustrates an exemplary method of diagnosing an error associated with a user account; and

FIG. 6 illustrates an exemplary method of centralized event logging and processing of log event entries.

### DETAILED DESCRIPTION

Computer-implemented systems and methods for monitoring multiple services are disclosed. The following non-limiting example is provided to help introduce the general subject matter of certain embodiments.

### Illustrative Embodiment of an Integrated Portal

Certain embodiments of the present disclosure provide methods and systems for monitoring multiple services associated, for example, with the delivery of IT, communication, and other network-based functionalities.

The term “eco-system” is used herein to refer to the combination of services provided to a customer as well as the set of systems that support the delivery of those services.

An example of services that make up an ecosystem may include network access (i.e., broadband cable or high-speed DSL), cloud hosting, mobile internet, voice over IP, etc. Systems that support delivery of services may include management systems. A management system may allow a customer to configure characteristics of a service provided. A management system may provide a gateway to allow a customer to access support or online services to manage the provision of multiple services. A system may provide a secure online customer portal to provide an interface that allows a customer to access and maintain some or all of the services that is provided as part of the customer's account.

An integrated monitoring tool such as an integrated portal may provide efficient monitoring of an eco-system, for example, by monitoring all systems and services in an eco-system concurrently. This may include the display of graphs or values that indicate service quality measures such as performance, response time, etc.

Systems that make up an eco-system may be in a hosted environment or a non-hosted environment. Systems in a hosted environment are local to the service provider. That is, a service provider runs a system in a hosted environment on behalf of a customer in their data center. Systems in a hosted environment, since local to the service provider, are monitored internally by the service provider. For example, any system running software as a service application (SaaS) that runs on a service provider's computer device is a system in a hosted environment.

Systems in a non-hosted environment include any system or service that is not provided by the service provider in a hosted environment. These systems are local to the customer as they run on the customer's computer devices. Systems in a non-hosted environment can be monitored remotely by the service provider.

An integrated portal provides a centralized, integrated, on demand gateway to each system monitored, whether in a hosted or non-hosted environment. Systems that make up an eco-system periodically send status information to the integrated portal. Alternatively, the integrated portal may query each system, for example, using an application programming interface (API) call.

Status information comprises information about a particular system and can include information about delivery of voice, data, or Internet service to one or multiple locations. Hence status information may include service quality measures of such services such as response time, availability of the service, etc.

Once status information is received, the integrated portal assembles for display the status information for each of the multiple services that make up the eco-system. The status information for each of the multiple services is displayed by the integrated portal for example as a concurrent view of the status information for each of the multiple services that is being monitored.

For example, an eco-system may include (1) a billing system, (2) a ticketing system, (3) a cloud hosting management system, (4) a SaaS tool that provides delivery of a service, (5) a SaaS tool for e-commerce payment processing, and (6) an SaaS tool for managing quotes. Each of the six exemplary systems would provide status information about the delivery of the service to the integrated portal. The status information may include, for example, whether the system providing the service is running, the response time of the system for a period of time (i.e., for the past twelve hours), the average availability of the system, and the average response time.

The status information from each system may be assembled to be displayed concurrently with the status information of the other systems that make up the customer's eco-system. Assembly of the status information may group certain information for display. For example, response time data may be amalgamated to present summary information useful in understanding the status of the entire ecosystem. Additionally or alternatively, the status information for each system may be separated or otherwise graphically-organized to provide concurrent snapshots of each system to make it easier to identify and understand the nature and extent of a bottleneck or other anomaly or to otherwise present useful information.

The term “widget” refers to a generic type of software application comprising portable code intended for one or more different software platforms.

Status information may be displayed using widgets. In one embodiment, a separate widget for each system being monitored may be used to display the respective status information. The widget may comprise code that controls the collection and/or display of appropriate information for the respective service status information. For example, in the context of a data service, status information may be displayed as a graph showing the response time every hour for the last twelve hours. In addition, the response time and availability of a system may be displayed as a value (i.e., average availability or average response time). The widget may also include graphically icons, for example, using different colors to indicate present service measurements. For example, a red circle may be displayed as part of a system widget for a data service if the response time of that particular system is below a set threshold. Likewise, a color icon indicating whether the system is running may be red if the system is down.

### Centralized Logging and Configurable Listener

A configurable listener can handle events generated by one or more of the monitored systems. Events from any of the monitored systems can be logged on a single source repository such as a log database. The logged events may originate from any source that generates or receives event entries from a system. Sources may include any of the systems in the coo-system or any database that contains logged events from any of the systems in the eco-system. For example, if a network service is experiencing a heavy load of traffic, the system monitoring that network service may generate an event entry and log the entry in the log database. Ideally, all logged events from all of the systems that make up an eco-system are accumulated in the log database. Thus the log database offers a centralized location for all logged events from any of the systems that make up an ecosystem.

A configurable listener accesses the log database periodically and categorizes the logged events based on configurable rules. For example, the logged events may be categorized based on the system that generated the event or may be categorized based on the severity of the event logged. After an event is categorized, the configurable listener, using configurable rules, analyzes the event to diagnose the cause and determine if action is necessary. Appropriate steps are then executed to implement the necessary action. Additionally, the configurable listener may maintain a history of all logged events. The history of a logged event may include but is not limited to an identification of the logged event, the determined cause, and the action taken.

For example, a listener can categorize an event logged in the log database as an alert from a management system of one of the provided services. Once categorized, the configurable listener uses rules to analyze the alert and diagnose the cause. Categorizing the event as an alert from the management system allows the configurable listener to access the appropriate rules for analyzing that event. A course of action, based on the rules, is determined. Examples of actions that may be taken include, but are not limited to, communicating details of the event and any appropriate recovery actions through appropriate channels (i.e., email, text, etc.) to a configurable list of recipients, rebooting a server, restarting a service, or pushing an alert or event information directly to a portal, mobile application, etc.

If the integrated portal receives log event information or an alert, the information received is incorporated into the status information that is displayed. Depending on the information received, and on rules the integrated portal may access, the alert may be immediately displayed or added as part of the information already displayed. The event information or alert may be displayed, for example, as a separate window on the integrated portal display or as part of the widget that is assembled for a particular system.

### Automated Testing and Recovery

The integrated portal also provides automated testing one or more of the systems being monitored. Automated user-interface tests are provided to troubleshoot errors that a customer may encounter while using any of the systems monitored. For example, if a user cannot log on to a system using his or her user account, the integrated portal could be notified. Once a notification is received, one or more automated or semi-automated tests may be triggered and/or performed. In the example of a user being unable to log on using his or her account information, one or more test may be used to determine whether the issue is specific to the particular user, to a particular group of user, or is generally an issue for all users. One exemplary test simulates logging on to the system two different ways: (1) using the particular user's account and (2) using a generic user identification. The automated tests run as a specific user and as a generic user helps to narrow the cause of the problem. For example, if the automated test does not succeed logging on using the user account but does succeed logging on as a generic user, the issue may be localized to the user as opposed to the system. The results of such automated tests may be routed through a configurable rule driven database to determine a recovery action. Actions may include communicating the test results and possibly a recovery procedure through appropriate channels of email or text or performing the appropriate recovery procedures.

### Integrated Portal on Portable Device

In another embodiment, the integrated portal may be accessed and used from remote locations and remote devices such as portable devices. Thus, if a user accesses the integrated portal through a portable device, such as a phone, status information regarding one or more of the systems is provided to the portable device for display. Additionally, the status information provided may be location specific. The integrated portal may identify the location of the portable device and tailor the status information that is provided based on the location identified for the portable device. For example, if one of the systems monitors broadband cable internet and this service is experiencing an outage in the location identified for the mobile device, the status information provided to the mobile device would include information regarding the outage. This information may include, for example, the length of time of the outage, when service is expected to resume, and any other information pertinent to the outage.

These illustrative examples are given to introduce the reader to the general subject matter discussed here and are not intended to limit the scope of the disclosed concepts. The following sections describe various additional embodiments and examples with reference to the drawings in which like numerals indicate like elements.

### Exemplary System

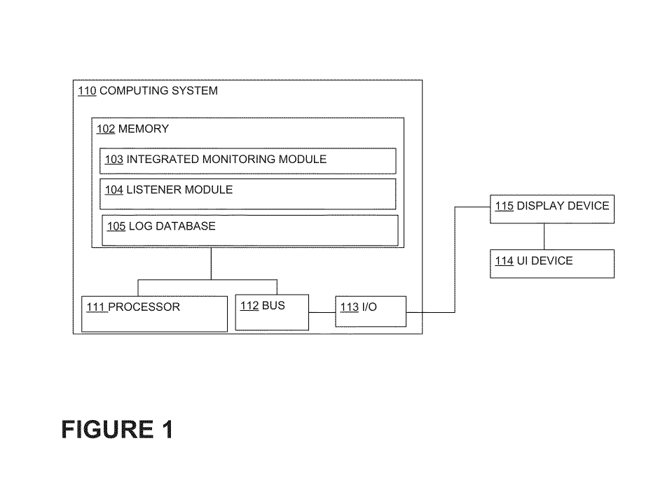

Referring now to the drawings, FIG. 1 is a block diagram depicting an example computing system 110 for implementing certain embodiments. The computing system 110 comprises a computer-readable medium such as a processor 111 that is communicatively coupled to a memory 102 and executes computer-executable program instructions and/or accesses information stored in the memory 102. The processor 111 may comprise a microprocessor, an application-specific integrated circuit (“ASIC”), a state machine, or other processing device. The processor 111 can include or may be in communication with computer-readable medium storing instructions that, when executed by the processor 111, cause the processor to perform the steps described herein.

The computing system 110 may also comprise a number of external or internal devices such as input or output devices. For example, the computing system 110 is shown with an input/output (“I/O”) interface 113, a display device 115, and any other user interface devices 114 such as a mouse. A bus 112 can also be included in the computing system 110. The bus 112 can communicatively couple one or more components of the computing system 110.

The memory 102 can include any suitable computer-readable medium. An integrated monitoring module 103 stored in memory 102 can configure the processor 111 to monitor multiple systems that make up an eco-system providing an integrated portal to systems of an eco-system. Additionally, memory 102 can include a listener module 104 and a log database 105. Listener module 104 can configure the processor 111 to access and analyze logged events stored in log database 105 and determine a course of action depending on configurable rules. Note that listener module 104 and log database 105 may be stored in the same memory 102 of computing system 110 as the integrated monitoring module 103. Alternatively, integrated monitoring module 103, listener module 104, and log database 105 may be on separate memory devices of the same computer system 110 or may be kept on separate computer systems. In some embodiments, the integrated monitoring module 103 or the listener module 104 may be software modules included in or accessible by separate applications executed by the processor 111. In other embodiments, the integrated monitoring module 103 and the listener module 104 can be a stand-alone modules executed by processor 111.

The computing system 110 can include any suitable computing device for executing the integrated monitoring module 103 or the listener module 104. Non-limiting examples of a computing device include a desktop computer, a tablet computer, a laptop computer, or any other computing device suitable for monitoring various systems.

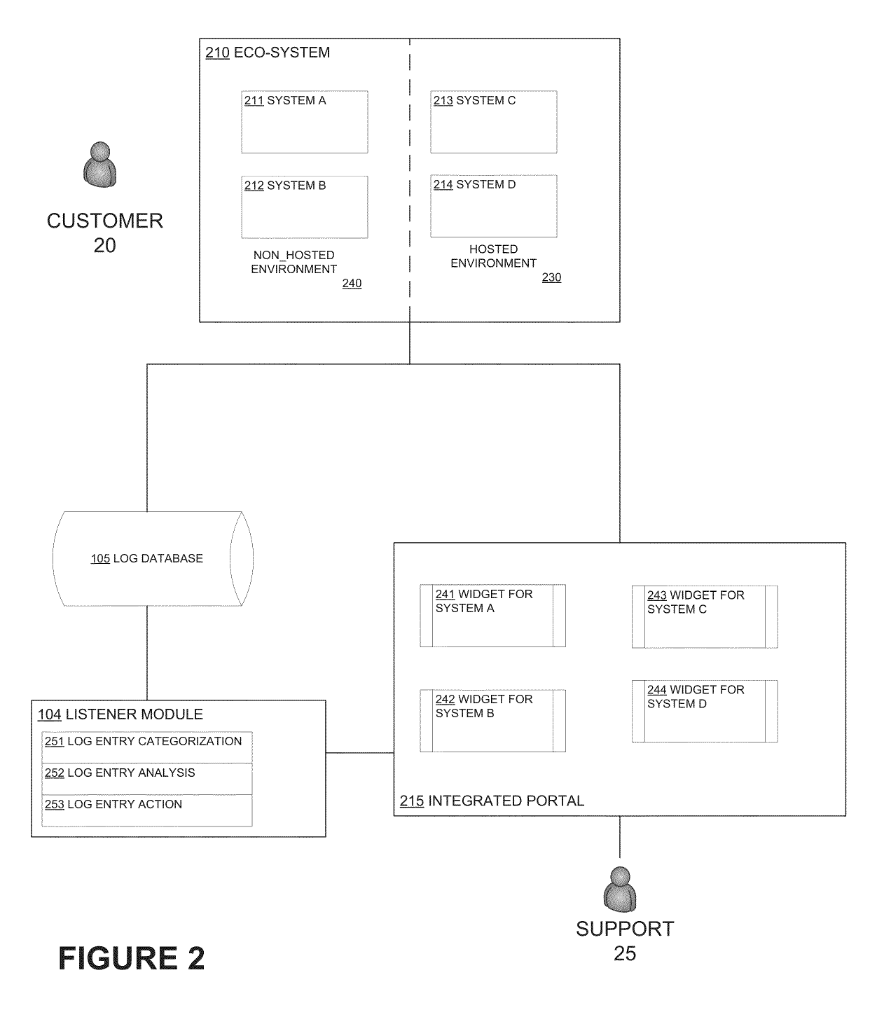

FIG. 2 is a block diagram illustrating an exemplary computing environment. An co-system 210 comprising multiple systems A-D 211, 212, 213, 214 that are associated with one or more services provided to a customer 20 are shown. System C 213 and system D 214 are systems in a hosted environment 230 that are provided by applications running on a local computing device of the service provider. These systems may be integrated using an Enterprise Service Bus (ESB). Systems 211 and 212 are systems in a non-hosted environment 240 that may be running on a customer's computing device.

Each of systems A-D 211, 212, 213, and 214 interfaces through an application programming interface (API) with integrated monitoring module 103 which provides an integrated portal 215 displaying status information from each of the multiple systems, system A 211, system B 212, system C 213, and system D 214. Through the API, the integrated monitoring module 103 receives status information from each of the multiple systems A-D, 211, 212, 214, and 215. The status information comprises information about the delivery of information technology, voice, data or Internet service.

Integrated monitoring module 103 assembles the status information for each of the multiple systems into an integrated portal 215. Integrated portal 215 provides an interface that displays a status information for some or all of the multiple systems. The integrated portal 215 may be displayed as a dashboard with widgets 241, 242, 243, and 244. In this example, status information for system A 211 is displayed by widget 241. Likewise, status information for system B 212 is displayed by widget 242, status information for system C 213 is displayed by widget 243 and status information for system D 214 is displayed by widget 244. Widgets 241-244 may display the status information graphically using graphs, number values, color coded icons, etc.

Referring to FIG. 2, any events processed by any of the systems in eco-system 210 that are configured to be logged are stored in log database 105. Log database 105 is therefore a central repository of logged events for all systems 211, 212, 213, and 214 that make up eco-system 210. An example of a logged event may be a notice of error associated with a particular user account. The source of logged events in log database 105 may be systems 211, 212, 213, or 214 or any application or system associated with any of these systems, or any database that contains logged events from any of the systems or services associated with eco-system 210.

Listener module 104 periodically accesses the logged events in log database 105 and determines a course of action based on configurable rules 254. Courses of action include, but are not limited to, communicating the event logged and any appropriate recover procedures to a configurable list of recipients such as support or operational personnel. Automatic recover actions may also be initiated such as rebooting the computing device that runs the system, restarting a system, or restarting a service. Additionally, the logged event or information about the logged event may be sent directly to a portal such as integrated portal 215 or to any other application as determined.

In the event that the configurable rules 254 specify that the logged event or information about the logged event be sent to the integrated portal 215, the information regarding the event may be received by integrated monitoring module 103 and assembled as part of the status information for the respective system that generated the logged event. When the display of integrated portal 215 is shown, the information regarding the event may be displayed as part of the widget corresponding to the system that generated the logged event or may be displayed as a separate window in the portal. If the information regarding the event includes that the event is an alert, the alert information may be displayed immediately by integrated portal 215.

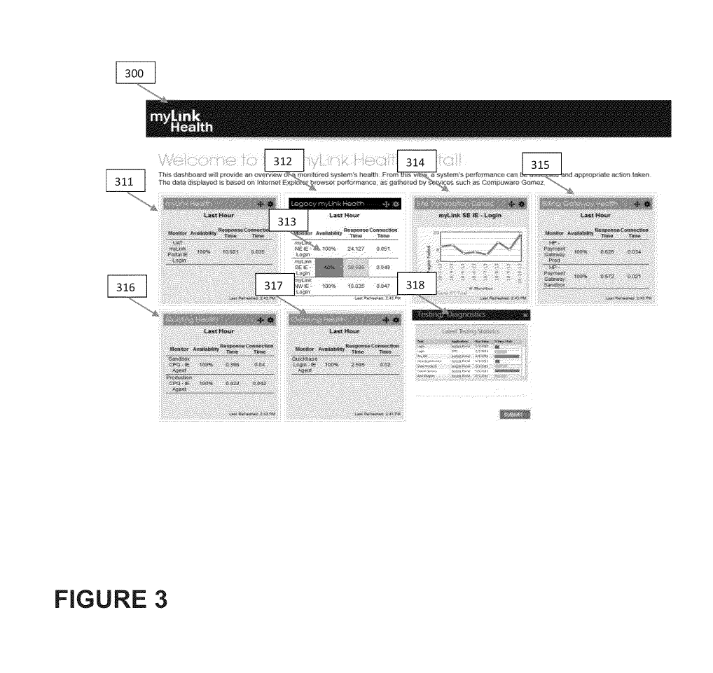

FIG. 3 illustrates an example of dashboard display 300 of an integrated portal. Widgets 311, 312, 314, 315, 316, 317, and 318 display status information corresponding to different services. For example, widgets 311 and 312 display status information corresponding to the availability, response rate and connection time of customer portals. Widget 311 displays the status information of one portal. Status information for multiple portals may be displayed concurrently in one widget as shown by widget 312 which displays status information for three separate portals. Color, format, sound, or display features (i.e., blinking, movement, alarm, etc.) may be used to flag any status information displayed. For example, highlighting a field red or yellow would be indicative that the status of a characteristic of a service monitored is within a certain threshold. As shown at 313, highlighting the “40%” availability information red indicates that the availability of that portal is below a configured threshold. Likewise, highlighting the “39,686” response time yellow indicates that the response time for that particular portal is reaching a configured threshold. Graphical displays may also be used to display status information. For example, Widget 314 shows a graph indicative of the number of pages that fail to display over a specified time period for a particular system. Such trending information may be displayed using any appropriate graph such as a line graph, bar graph, etc. Widget 315 displays status information corresponding to the current availability, response rate and connection time as it relates to a billing system. Widget 316 displays status information corresponding to the availability, response rate, and connection time for a quoting system. Widget 317 displays status information corresponding to the availability, response rate, and connection time for an ordering system. Widget 318 displays information corresponding to diagnostic tests run on several systems. These tests may check the availability, response, connectivity, and any other functionality of the various systems monitored and widget 318 would display the results of such tests. Note that the status information displayed by any widget may be configurable. The display of each widget may be configured interactively, for example, through the use of a menu where a user specifics how information should be displayed. For example, the type of graph used to display information may be chosen from a menu of graphs provided, a start date and time and an end date and time may be selected to limit the amount of information displayed, the type of view the widget should provide may be selected to be a grid or a chart.

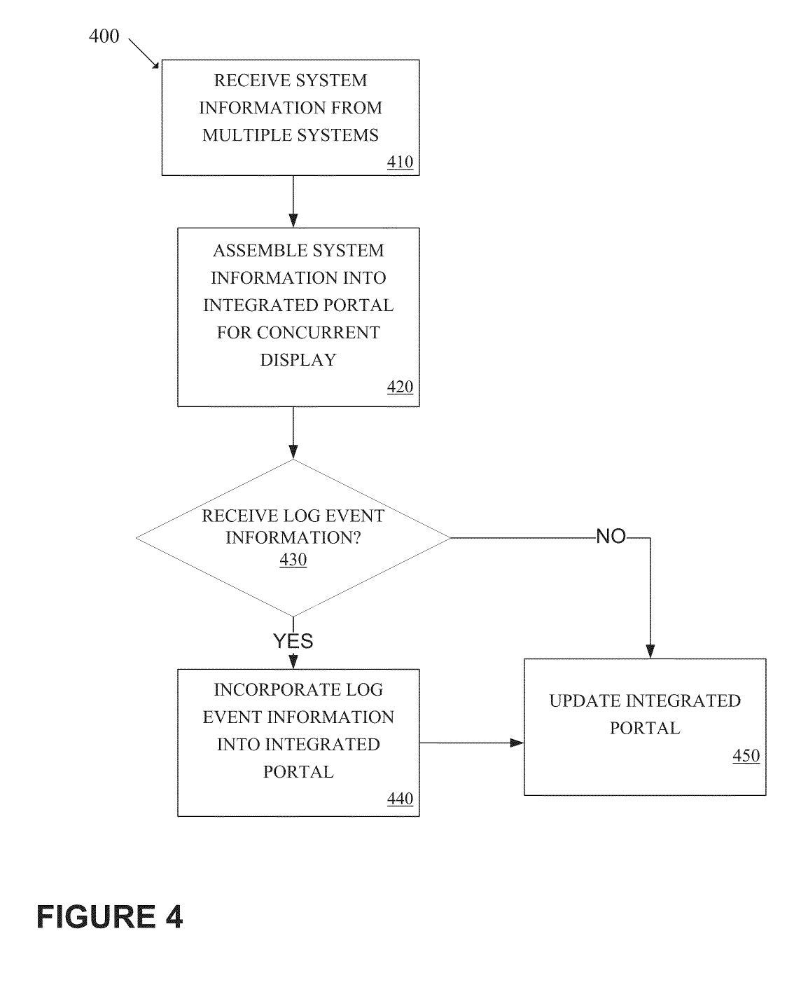

FIG. 4 is a flow chart illustrating one method 400 of providing an integrated portal according to one embodiment. The elements of this method 400 may be implemented by one or more of the components depicted in FIGS. 1 and 2. This and similar methods may however be accomplished or implemented on any suitable device or system.

In the method 400 shown in FIG. 4, at block 410, an integrated portal provided by an integrated monitoring module receives status information from the multiple systems that makes up an eco-system. Systems that make up an eco-system may include systems in a hosted and non-hosted environment. Status information comprises information about delivery of information technology. This includes but is not limited to voice, data, or Internet service to multiple locations provided by each system in an eco-system. Additionally, status information may include any information for providing diagnostics.

The integrated monitoring module assembles the status information for each of the multiple systems into an integrated portal that when displayed provides concurrent view of the status information for some or all of the multiple systems, as shown in block 420. The status information may be displayed graphically providing diagnostics pertaining to each of the multiple systems.

The integrated monitoring application may also update status information by receiving information associated with a logged event that was originally generated from a system being monitored. Information associated with a logged event may be provided by a listener module that has determined that the logged event should update status information being displayed on the integrated portal. If the integrated monitoring module receives log event information at block 430, the log event information received is incorporated into the corresponding status information provided by the integrated portal at block 440. The integrated portal is updated at block 450 thus when displayed, current information along with the log event information is displayed. Note that event log information may be an alert and thus may be displayed immediately either as part of the status information or as a separate window thus alerting any user of the received alert.

If no log event information is received at block 430, the integrated portal is updated at block 450 and when displayed, updated status information is included.

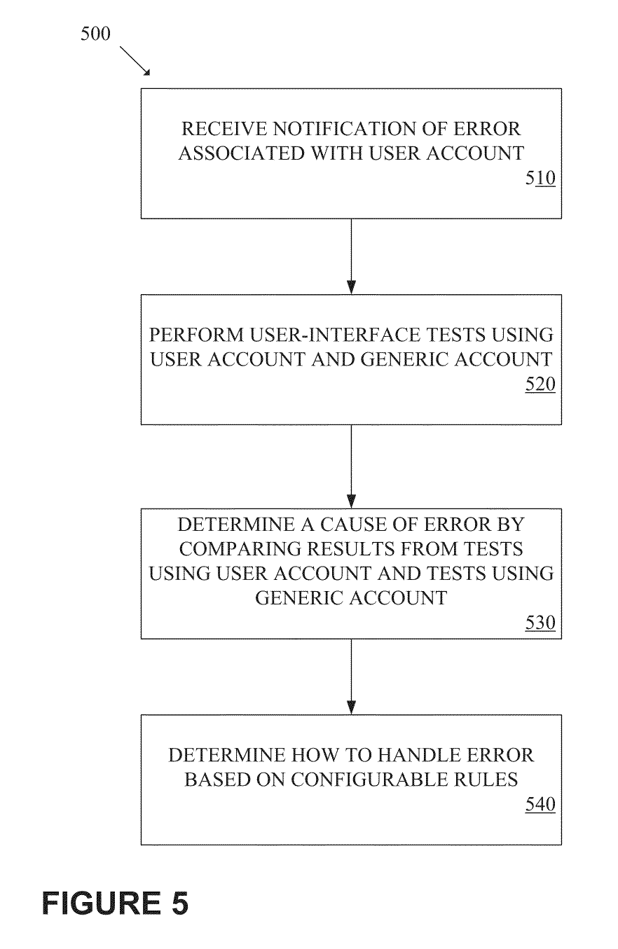

FIG. 5 illustrates an exemplary method 500 of diagnosing an error associated with a user account. The elements of this method 500 may be implemented by one or more of the components depicted in FIGS. 1 and 2. This and similar methods may however be accomplished or implemented on any suitable device or system.

In the method 500 shown in FIG. 5, at block 510, an integrated monitoring module that provides an integrated portal for an eco-system receives notification of an error associated with a user account. Such an error may occur, for example, as a user tries to configure a service that a system is monitoring using a user account. The integrated monitoring module would perform user-interface tests using the user account and using a generic account, as shown at block 520.

As shown at block 530, the integrated monitoring module would determine a cause of error by comparing results from performing tests using the user account and performing tests using a generic user account. Configurable rules are used to determine a course of action depending on the cause of error determined, as shown at block 540. For example, a notification may be sent to a configurable list of recipients. Alternatively, the system may be restarted or the computing device may be rebooted. The status information displayed by the integrated portal may also be updated.

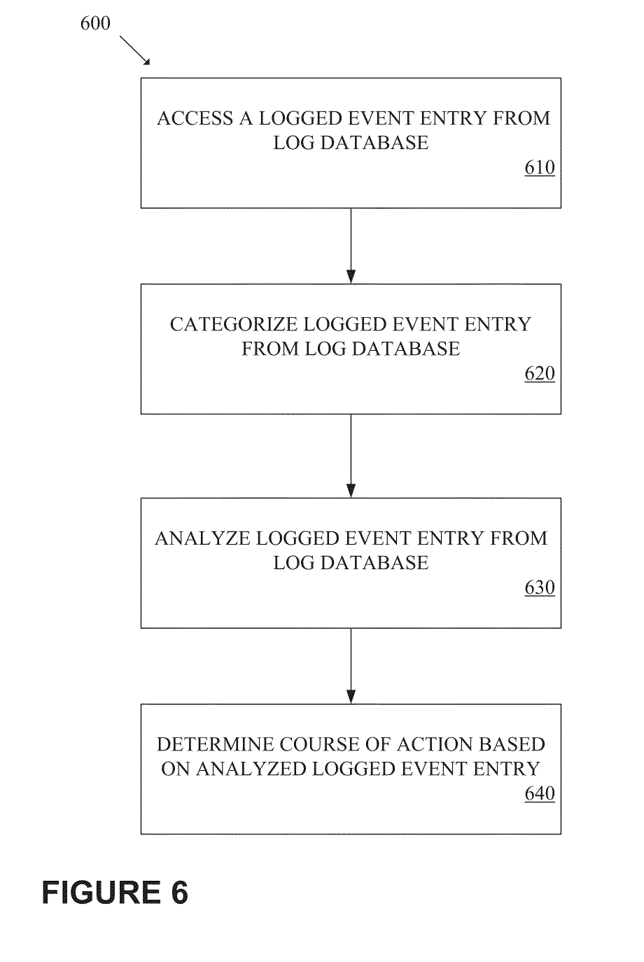

FIG. 6 illustrates an exemplary method 600 of centralized event logging and processing of event logs by a listener module. The elements of this method 600 may be implemented by one or more of the components depicted in FIGS. 1 and 2. This and similar methods may however be accomplished or implemented on any suitable device or system.

In the method 600, a log database contains information associated with events generated by any one of the systems being monitored. The logged events may be provided to the log database by the system associated with the event. Alternatively, the logged events may be provided by any application that is associated with the system or service, such as an application that allows configuration of a service. All logged events from any system being monitored in an co-system are centrally stored in a log database.

A listener module periodically accesses the logged events from log database, as shown at block 610. Using configurable rules, the listener application categorizes the logged event entry from the log database at block 620. Once categorized, the rules aid in analyzing the logged event entry at block 630 to determine a course of action for the logged event, as shown at block 640. A course of action may be to send a notification to a configurable list of recipients. Another course of action may be automatic recovery procedures such as restarting a system or rebooting a computer device.

### General

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of“adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

That which is claimed is:

1. A computer-implemented method comprising:
receiving status information for each of multiple services provided via multiple systems, wherein the status information comprises information about delivery of information technology, voice, data, or Internet service to multiple locations;
assembling, by a processor, the status information for each of the multiple services into a portal that when displayed provides a concurrent view of the status information for at least some of the multiple services; and
updating the portal with updated status information based on receiving periodic status updates to the status information for the multiple services.

2. The method of claim 1 further comprising monitoring the status information for each of the multiple services to provide diagnostics pertaining to each of the multiple services.

3. The method of claim 1, wherein the status information comprises availability information indicating availability or history of delivery of at least one service to the multiple locations for each of the multiple services, and wherein the portal presents the availability or history information.

4. The computer implemented method of claim 1 wherein the portal graphically represents the availability or history information separately for each of the multiple locations.

5. The method of claim 1, wherein the status information comprises response time information indicating how quickly each of the multiple services responds to a user-initiated request, and wherein the portal presents the response time information.

6. The computer implemented method of claim 1 wherein the multiple systems comprise systems in a hosted environment and systems in a non-hosted environment, wherein the hosted environment provides access to systems through a local application on a local computing device, and wherein the non-hosted environment provides remote access to systems.

7. The computer implemented method of claim 1 further comprising:
receiving a logged event comprising status information generated by one of the multiple systems; and
based on the logged event, automatically determining a course of action.

8. The method of claim 7 further comprising accessing a configuration file specifying parameters for processing the logged event, wherein the course of action is determined based on the configuration file.

9. The computer implemented method of claim 7 wherein the configuration file includes parameters specifying whether the logged event should be ignored or processed and rules specifying how to process the logged event.

10. The method of claim 7 wherein determining a course of action comprises:
communicating information about the logged event to recipients based on the configuration file; and
initiating a recovery procedure to reboot or reinitialize a device associated with the logged event.

11. The computer implemented method of claim 10 further comprising communicating a message notifying that recovery procedures were initiated to recipients based on a configuration file.

12. The computer implemented method of claim 7 further comprising logging the course of action determined or analysis of the logged event.

13. The computer implemented method of claim 1, wherein the portal is provided to a portable device.

14. The computer implemented method of claim 1 further comprising:
providing, by a processor, a portal comprising status information for each of multiple services provided via multiple systems, wherein the status information comprises information about delivery of information technology, voice, data, or Internet service to multiple locations;
based on receiving a notice of an error associated with a particular user account, performing a user-interface test using a generic user account and performing the user-interface test using a particular user account; and
determining a cause of the error by comparing first-results returned from performing the user-interface test using the generic user account to second-results returned from performing the user-interface test using the specified user account, wherein determining the cause of the error identifies whether the error is specific to the particular user account or not.

15. The computer implemented method of claim 13 wherein a recommendation is provided based on the cause of the error.

16. A computer-implemented method comprising:
receiving status information for each of multiple services provided via multiple systems, wherein the status information comprises information about delivery of information technology, voice, data, or Internet service to multiple locations;
identifying a location associated with a portable device to which the status information is be provided;
selecting status information from the status information for each of the multiple system based on a location of the portable device; and
providing, by a processor, the selected status information for display on the electronic device.

17. A computer-readable medium on which is encoded program code, the program code comprising:
program code for receiving status information for each of multiple services provided via multiple systems, wherein the status information comprises information about delivery of information technology, voice, data, or Internet service to multiple locations;
program code for assembling, by a processor, the status information for each of the multiple services into a portal that when displayed provides a concurrent view of the status information for each of the multiple services; and
program code for updating the portal with updated status information based on receiving periodic status updates to the status information for each of the multiple services.

18. The computer-readable medium of claim 17 further comprising:
program code for monitoring the status information for each of the multiple services to provide diagnostics pertaining to each of the multiple services.

19. The computer-readable medium of claim 17 further comprising:
program code for receiving a logged event comprising status information generated by one of the multiple systems; and
based on the logged event, automatically determining a course of action.

20. A system comprising:
a processor,
an integrated monitoring module configured, when executed by the processor, to
receive status information for each of multiple services provided via multiple systems, wherein the status information comprises information about delivery of information technology, voice, data, or Internet service to multiple locations;
assemble the status information for each of the multiple systems into a portal that when displayed provides a concurrent view of the status information of at least some of the multiple systems; and
update the portal with updated status information based on receiving periodic status updates to the status information for the multiple systems.
